(19) United States
(12) Patent Application Publication
(10) Pub. No.: US 2016/0318579 A1
(43) Pub. Date: Nov. 3, 2016

(54) ELECTRIC VEHICLE

(71) Applicant: YAMAHA HATSUDOKI KABUSHIKI KAISHA, Iwata-shi (JP)

(72) Inventor: Shidehiko MIYASHIRO, Shizuoka (JP)

(21) Appl. No.: 15/135,602

(22) Filed: Apr. 22, 2016

(30) Foreign Application Priority Data
Apr. 28, 2015 (JP) 2015-092146

(51) Int. Cl. B62M 7/02; B60L 11/18; B60K 1/04; B62K 11/04; B62K 25/28

(52) U.S. Cl. CPC B62M 7/02; B62K 11/04; B62K 25/283; B60K 1/04; B60L 11/1877; B62K 2204/00

(57) ABSTRACT

An electric vehicle includes a vehicle body frame, a swing arm supported on the vehicle body frame via a pivot shaft so as to swing in an up-down direction, a rear wheel supported on the swing arm, an electric motor, an output shaft to which a driving force of the electric motor is transmitted, an endless transmission member that transmits a driving force outputted from the output shaft to the rear wheel, a battery that supplies power to the electric motor, and a battery case that houses the battery. The output shaft is positioned lower than a lower end of the battery case and more forward than a rear end of the battery case in a side view. A movement restrictor that contacts the transmission member to restrict upward movement of the transmission member is mounted on the vehicle body frame or a member fixed to the vehicle body frame.

### BACKGROUND OF THE INVENTION

1. Field of the Invention

The present invention relates to an electric vehicle, and in particular, though not exclusively, to an electric vehicle that is straddled.

2. Description of the Related Art

WO 2013/061484 discloses an electric motorcycle having a battery case for storing a battery that is positioned near the middle of the motorcycle in the front-back direction. Similar to a typical motorcycle, the electric motorcycle has a swing arm that is supported so as to swing relative to a vehicle body frame and that transmits a driving force to the rear wheel via an endless transmission member such as a chain, or the like.

In the electric motorcycle disclosed in WO 2013/061484, in order to ensure a range of movement of the transmission member that follows the up-down movement of the swing arm, it is necessary to ensure a clearance by mounting the battery case far ahead of or above the transmission member. This makes it difficult to achieve a reduction in size. In reality, according to WO 2013/061484, the battery case is mounted so as to be displaced in the forward direction relative to the motor case, and this results in a vehicle that is relatively long.

It is possible to seek a clearance between the battery case and the transmission member by limiting the movement range of the swing arm by limiting the extension and contraction amount of the suspension. In this case, however, the riding comfort may deteriorate. Still further, it is possible to ensure a clearance between the battery case and the transmission member by reducing the size of the battery case. In this case, however, a decreased capacity of the battery and thus a shorter traveling distance may result.

### SUMMARY OF THE INVENTION

Preferred embodiments of the present invention have been conceived in view of the problems described above, and provide an electric vehicle of which a size is reduced without a deterioration in the riding comfort and/or the battery capacity.

At least one preferred embodiment of the present invention obviates or at least mitigates one or more of the problems or disadvantages in the prior art.

Various preferred embodiments of the present invention are described below. Some optional and/or other preferred features are also described below.

According to a preferred embodiment of the present invention there is provided an electric vehicle.

The electric vehicle preferably includes a vehicle body frame.

The electric vehicle preferably includes a swing arm which is supported on the vehicle body frame, for example, via a pivot shaft so as to swing in an up-down direction.

The electric vehicle preferably includes a rear wheel supported on the swing arm.

The electric vehicle preferably includes an electric motor.

The electric vehicle preferably includes an output shaft to which a driving force of the electric motor is transmitted.

The electric vehicle preferably includes an endless transmission member, for example, that transmits a driving force outputted from the output shaft to the rear wheel.

The electric vehicle preferably includes a battery, for example, that supplies power to the electric motor.

The electric vehicle preferably includes a battery case, for example, that houses the battery.

The output shaft is preferably positioned lower than a lower end of the battery case and/or more forward than a rear end of the battery case in a side view of the electric vehicle.

A movement restrictor that preferably contacts the transmission member to restrict upward movement of the transmission member is preferably mounted on the vehicle body frame or a member fixed to the vehicle body frame.

According to a preferred embodiment of the present invention, even in the case where the output shaft is positioned lower than the lower end of the battery case and more forward than the rear end of the battery case in a side view, the provision of the movement restrictor makes it possible to prevent the battery case from contacting the transmission member. This arrangement makes it possible to reduce the size of the electric vehicle without deteriorating the riding comfortable and/or the battery capacity. The pivot shaft is preferably positioned lower than the lower end of the battery case and/or more forward than the rear end of the battery in a side view.

The transmission member and the battery case preferably at least partially overlap each other in a plan view of the electric vehicle.

The movement restrictor preferably contacts the transmission member at a position more rearward than the rear end of the battery case.

The electric vehicle preferably includes a suspension which is positioned between the vehicle body frame and the swing arm.

The movement restrictor preferably contacts the transmission member, for example, at least when the suspension is in a most contracted state.

The movement restrictor is preferably positioned lower than the battery case along a circumferential direction with the output shaft defining a center of the circumference.

The vehicle body frame preferably includes a rear frame which extends diagonally rearward and upward, for example, from a position behind the battery case.

The movement restrictor is preferably mounted on a front end portion of the rear frame.

The movement restrictor may be mounted on the battery case.

The electric vehicle preferably includes a motor case that houses the electric motor. A lower edge of the battery case and an upper edge of the motor case may be assembled together or merely adjacent to or in abutment with one another.

The electric vehicle preferably includes a motor case that houses the electric motor. A recess is preferably provided on the motor case, for example, so as to open at least downward. The transmission member is preferably positioned inside the recess.

The electric vehicle is preferably a vehicle that is straddled, such as a motorcycle or bicycle.

It will be appreciated that features analogous to those described in relation to any of the above preferred embodiments may be individually and separately or in combination applicable to any of the other preferred embodiments.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of an electric vehicle according to a preferred embodiment of the present invention.

FIG. 2 is an enlarged side view showing a major portion of the electric vehicle of FIG. 1.

FIG. 3 is an enlarged perspective view showing a major portion of the electric vehicle of FIG. 1.

FIG. 4 a cross-sectional view of a major portion of the electric vehicle of FIG. 1.

### DETAILED DESCRIPTION OF THE PREFERRED EMBODIMENTS

Preferred embodiments of the present invention will now be described with reference to the accompanying drawings.

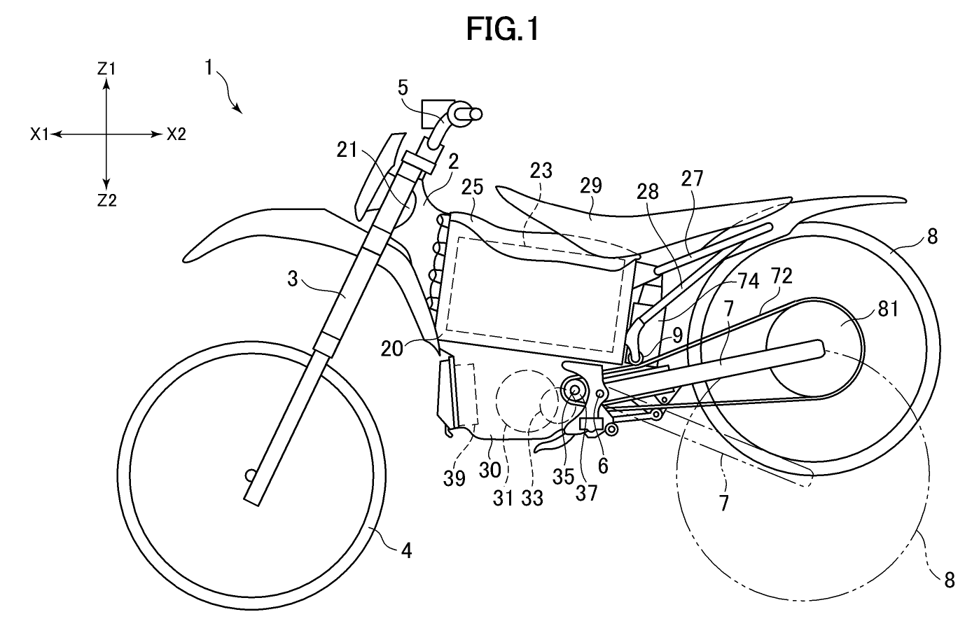

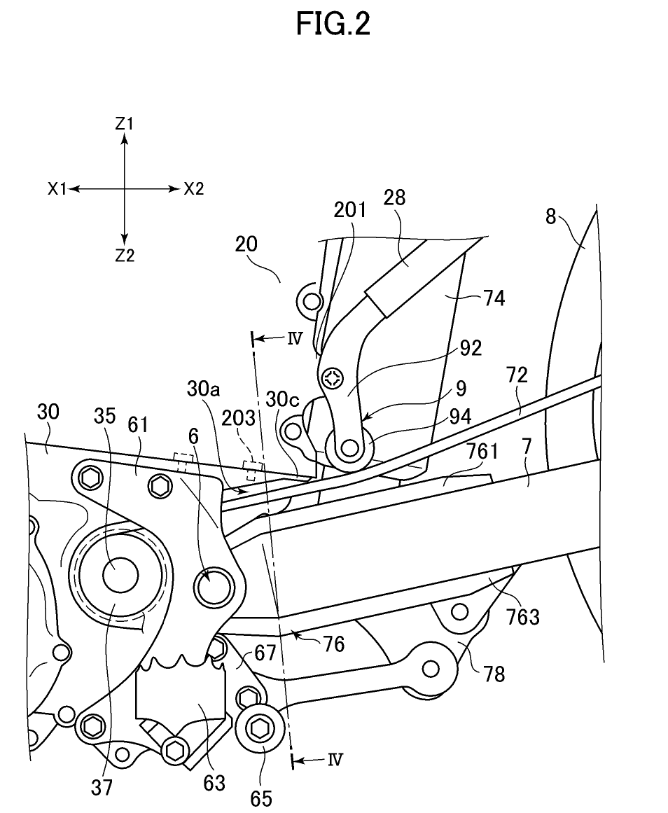

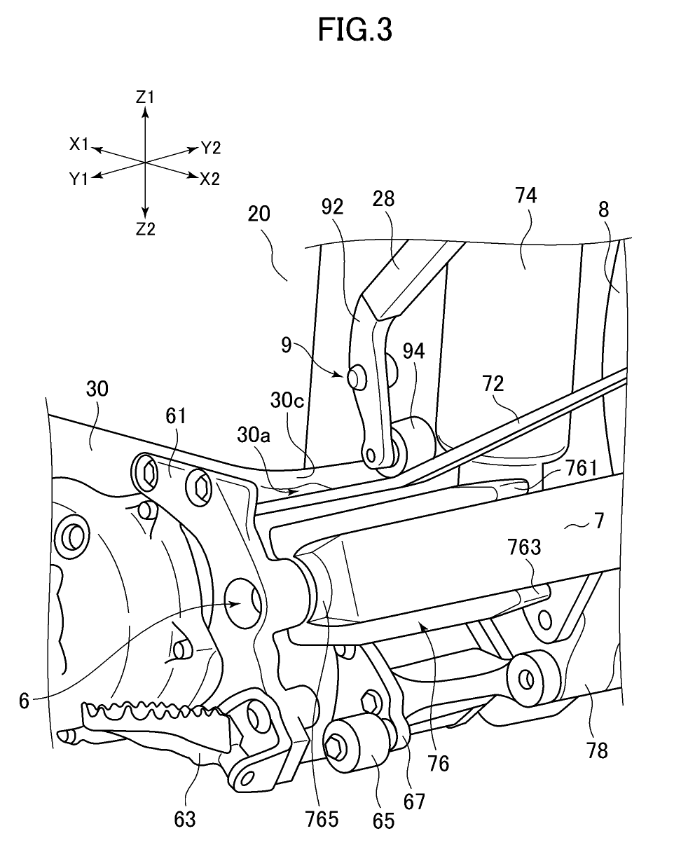

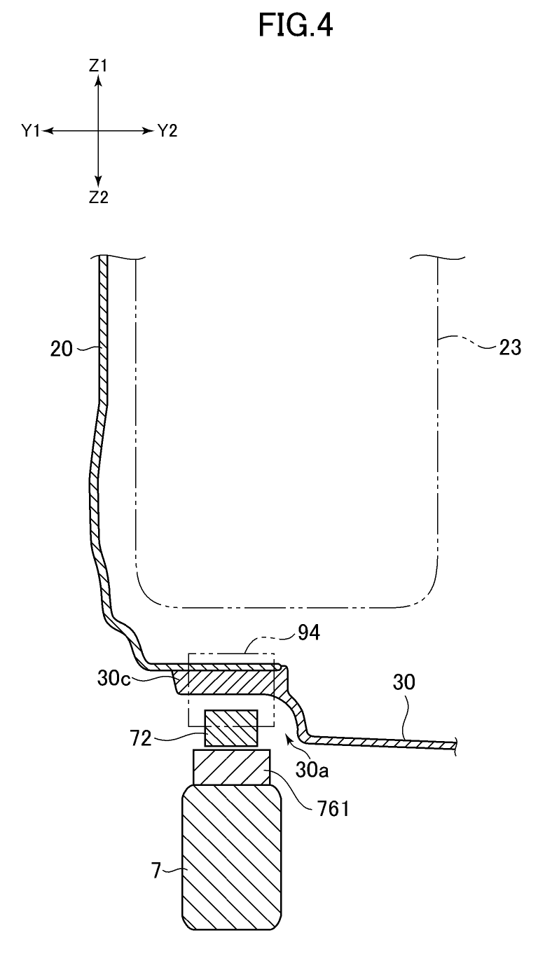

FIG. 1 is a side view of an electric vehicle 1 according to a preferred embodiment of the present invention. FIG. 2 is an enlarged side view of an area near a pivot shaft 6 of the electric vehicle 1. FIG. 3 is a perspective view showing an area near the pivot shaft 6 of the electric vehicle 1 viewed from the left rear side thereof. FIG. 4 is a cross-sectional view along the line IV-IV shown in FIG. 2. Note that X1 and X2 shown in the respective diagrams indicate the forward and rearward directions, respectively; Y1 and Y2 indicate the leftward and rightward directions, respectively; and Z1 and Z2 indicate the upward and downward directions, respectively.

In the drawings, a swing arm 7 and a rear wheel 8 are shown with a suspension 74 in the most contracted state. In FIG. 1, the swing arm 7 and the rear wheel 8 with the suspension 74 in an unloaded state are indicated by the long dashed double-short dashed line.

In the present preferred embodiment the electric vehicle 1 is an electric vehicle that is straddled, for example. In the following, an electric motorcycle will be described as one example of an electric vehicle that is straddled. This, however, is not limiting, and the electric vehicle 1 may be an electric automobile, such as an all terrain vehicle, for example.

The electric vehicle 1 preferably includes a monocoque vehicle body frame 2, for example. A head pipe 21 is mounted on the front portion of the vehicle body frame 2, and a front fork 3 is supported on the head pipe 21 so as to rotate in the left-right direction. A front wheel 4 is mounted on the lower portion of the front fork 3, and a handle 5 that steers the electric vehicle 1 is mounted on the upper portion of the front fork 3. A pivot shaft 6 is mounted below the vehicle body frame 2, and a swing arm 7 is supported on the lower portion of the pivot shaft 6 so as to swing in the up-down direction. A rear wheel 8 is supported on the rear portion of the swing arm 7.

The electric vehicle 1 includes an electric motor 31 as a power source that generates a driving force to drive the rear wheel 8, and a battery 23 as an energy source to supply power to the electric motor 31. A lithium ion battery, for example, is preferred as the battery 23. The driving force of the electric motor 31 is decelerated by a decelerator 33 before being transmitted to an output shaft 35 and further to the rear wheel 8 via a transmission member 72 such as a chain, a belt or the like.

The battery 23 is housed in a battery case 20 provided at least partially or directly below the seat 29. The battery case 20 defines a portion of the vehicle body frame 2. The battery case 20 preferably has a box shape that is open upwards, and a cover 25 that is able to be opened and closed is attached to the upper portion of the battery case 20. When the seat 29 is removed and the cover 25 is opened, it is possible to access the inside of the battery case 20.

In the present preferred embodiment, the battery 23 is removed from the battery case 20 and charged by an external charger. In the present preferred embodiment, a plurality of batteries 23 are housed in the battery case 20. The size and weight of each battery 23 are appropriately designed so that the battery 23 is able to be carried manually. With the above arrangement, the ease of manually carrying the battery 23 and an output and capacity necessary for the electric vehicle 1 to run are both ensured.

Behind the battery case 20, an upper rear frame 27 and a lower rear frame 28 are mounted. The upper rear frame 27 is connected to the upper portion of the rear surface of the battery case 20, while the lower rear frame 28 is connected to the lower portion of the rear surface of the battery case 20. In detail, the lower rear frame 28 is connected to the battery case 20 via an arm 92 of a movement restrictor 9 to be described below. This, however, is not limiting, and the lower rear frame 28 may be directly connected to the battery case 20 or connected to another frame member.

Below the battery case 20, a motor case 30 that houses the electric motor 31, the decelerator 33, and the output shaft 35 is mounted. In the motor case 30, a motor controller 39 that is configured or programmed to control the power supplied from the battery 23 to the electric motor 31 is housed. The electric motor 31 is preferably positioned at the middle of the motor case 30 in the front-back direction. The motor controller 39 is preferably positioned ahead of the electric motor 31. The output shaft 35 is preferably positioned behind the electric motor 31. The battery case 20 and the motor case 30 are preferably made of a metallic based material such as aluminum, iron, magnesium, or alloy of any thereof, for example.

The motor case 30 preferably has a box shape that opens upward, and is connected to the lower end portion of the battery case 20. Specifically, the upper edge of the motor case 30 preferably has a shape corresponding to a shape of the lower edge of the battery case 20, and the lower edge of the battery case 20 and the upper edge of the motor case 30 are assembled together and fixed to each other by a fixing device, such as a screw 203, on the inside of the battery case 20. With the above arrangement, since the electric motor 31 or the like housed in the motor case 30 is positioned below, i.e. directly below, the battery case 20, it is possible to achieve a reduction in the size of the electric vehicle 1 in the front-back direction.

As shown in FIGS. 1 and 2, the output shaft 35 is positioned lower than the lower end of the battery case 20 and more forward than the rear end of the battery case 20 in a side view. On the left end portion of the output shaft 35 that is exposed outside the motor case 30, a driving side rotating member 37, such as a sprocket, a pulley, or the like, that transmits a driving force of the output shaft 35 to an endless transmission member 72, such as a chain, a belt, or the like, is mounted.

On the left surface and the right surface of the motor case 30, a pair of brackets 61 are mounted, and the pivot shaft 6 is mounted in a position between the pair of left and right brackets 61 behind the motor case 30. The bracket 61 is preferably U-shaped or substantially U-shaped and projects rearward, and is fixed to the side surface of the motor case 30 on the upper and lower portions thereof by a screw or the like. The portion projecting rearward of the bracket 61 is connected to the pivot shaft 6. Further, a footrest 63 is mounted on the lower portion of the bracket 61.

As shown in FIGS. 1 and 2, the pivot shaft 6 is also positioned lower than the lower end of the battery case 20 more forward than the rear end of the battery case 20 in a side view. The pivot shaft 6 is positioned behind the output shaft 35 in a side view such that the upper portion and lower portion of the bracket 61 sandwich the output shaft 35 in the up-down direction in a side view. The bracket 61 mounted on the left side surface of the motor case 30 is positioned more leftward than the driving side rotating member 37 and the transmission member 72.

On the pivot shaft 6, the front end portion of the swing arm 7 is supported so as to rotate so that the swing arm 7 is able to swing in the up-down direction with the pivot shaft 6 as the center. The suspension 74 is positioned between the vehicle body frame 2 and the swing arm 7. In the present preferred embodiment, the suspension 74 is positioned behind the battery case 20 and is able to extend or contract in the up-down direction. The upper end portion of the suspension 74 is connected to the upper rear frame 27, while the lower end portion of the same is connected to the swing arm 7 via a link 78.

The endless transmission member 72 is wound around the driving side rotating member 37 mounted on the output shaft 35 and a following side rotating member 81, such as a sprocket, a pulley, or the like, mounted on the rear wheel 8. A driving force from the output shaft 35 is transmitted from the driving side rotating member 37 mounted on the output shaft 35 to the transmission member 72 and further to the following side rotating member 81, and the rear wheel 8 resultantly rotates. The transmission member 72 swings in the up-down direction together with the swing arm 7.

As shown in FIGS. 2 and 4, the transmission member 72 is positioned so as to travel below the lower left rear portion of the battery case 20. In the present preferred embodiment, the entire transmission member 72 in the left-right direction is fully overlapped by the battery case 20 in a plan view. With this arrangement, it is possible to reduce the size of the electric vehicle 1 in the left-right direction. This, however, is not limiting, and only a portion of the transmission member 72 in the left-right direction may be overlapped by the battery case 20 in a plan view.

Further, a recess 30a is provided on the upper left rear portion of the motor case 30 so as to be open downward and leftward. The transmission member 72 is positioned in the recess 30a. The recess 30a is shaped so that the transmission member 72 does not contact the motor case 30. Specifically, the recess 30a is shaped so that the transmission member 72, when having moved upward to contact a portion or member 94 of the movement restrictor 9 (to be described below), does not contact any portion above the recess 30a. The portion above the recess 30a corresponds to a connection 30c that is connected to the lower left rear end portion of the battery case 20.

A U-shaped or substantially U-shaped seal guard 76, which sandwiches the swing arm 7 in the up-down direction, is supported on the pivot shaft 6 so as to swing in the up-down direction. The seal guard 76 includes a pair of arms 761, 763 that rearwardly extend upward and downward, respectively, from a ring-shaped shaft portion 765 that is supported so as to rotate on the pivot shaft 6. The arms 761, 763 cover the top and bottom respective surfaces of a portion of the swing arm 7 near the pivot shaft 6 to prevent the transmission member 72 from directly contacting the swing arm 7.

Below the seal guard 76, a chain roller 65 that prevents the transmission member 72 from deflecting is mounted. The chain roller 65 is positioned behind and below the pivot shaft 6 in a side view, and fixed to the motor case 30 via a bracket 67. The chain roller 65 contacts the transmission member 72 to apply tension when the swing arm 7 is on or near a straight line connecting the output shaft 35 and the pivot shaft 6. While the swing arm 7 is moving to its highest position (the position where the suspension 74 is in the most contracted state), the chain roller 65 separates from the transmission member 72.

In the present preferred embodiment, the output shaft 35 is positioned lower than the lower end of the battery case 20 and more forward than the rear end of the same in a side view, as described above. Therefore, it is necessary to ensure a clearance between the transmission member 72 that swings in the up-down direction together with the swing arm 7 and the lower left rear end portion of the battery case 20. However, in an attempt to further reduce the front-back length of the electric vehicle 1, the clearance tends to decrease when enlarging the battery 23 in the front-back direction in order to ensure larger capacity, or mounting the battery 23 in a lower position to ensure a lower barycenter.

In view of the above, the movement restrictor 9 to be described below is provided to prevent the transmission member 72 that swings in the up-down direction from contacting the lower left rear end portion of the battery case 20 or the connection 30c of the motor case 30 connected to the lower left rear end portion. Note that the description below mainly describes the connection 30c of the motor case 30 connected to the lower left rear end portion of the battery case 20.

The movement restrictor 9 includes an arm 92 mounted on the vehicle body frame 2 and the contact 94 supported by the arm 92. The contact 94 is, for example, a chain roller supported so as to rotate on the lower end portion of the arm 92. This, however, is not limiting, and the contact 94 may be a chain slider fixed to the lower end portion of the arm 92, for example. The contact 94 is preferably made of rubber, for example.

The arm 92 is mounted on the front end portion of the lower rear frame 28 and extends downward. The arm 92 is mounted also on the lower portion of the rear surface of the battery case 20 so as to be present between the lower rear frame 28 and the battery case 20. Specifically, the upper end portion of the arm 92 is fixed to the front end portion of the lower rear frame 28 by a weld or the like, and a middle portion of the arm 92 is fixed to a bracket 201 mounted on the lower portion of the rear surface of the battery case 20 by a screw or the like. The arm 92 is mounted on the vehicle body frame 2 or a member fixed to the vehicle body frame 2. That is, the arm 92 is fixed to a member that does not swing relative to the vehicle body frame 2.

The position where the arm 92 is mounted is not limited to any particular position, as long as the position allows the contact 94 to prevent the transmission member 72 from contacting the connection 30c of the motor case 30. For example, the arm 92 may be mounted on a middle portion or a rear end portion of the lower rear frame 28 or on the upper rear frame 27. Alternatively, the arm 92 may be mounted alone on the battery case 20. In the case where the battery case 20 does not define a portion of the vehicle body frame 2, the arm 92 may be mounted on the battery case 20.

The contact 94 makes contact with the transmission member 72 to locally restrict upward movement of the transmission member 72, and further to prevent the transmission member 72 from contacting the connection 30c of the motor case 30.

The contact 94 makes contact with the transmission member 72 in a position more rearward than the rear end of the battery case 20. The contact 94 is positioned more rearward than the rear end of the battery case 20 and more forward than the rear wheel 8. In order to prevent contact between the transmission member 72 and the connection 30c of the motor case 30, it is preferable that the contact 94 is positioned near the rear end of the battery case 20. For example, the contact 94 may be positioned more forward than the rear end of the seal guard 76 or positioned overlapping the suspension 74 in a side view. Note that the contact 94 may be positioned more forward than the rear end of the battery case 20 and lower than the lower end of the same. However, in order to ensure a lower barycenter, it is preferable that the contact 94 is positioned more rearward than the rear end of the battery case 20.

At least when the swing arm 7 is at the highest position (the position where the suspension 74 is in the most contracted state), the contact 94 makes contact with the transmission member 72. For example, the contact 94 makes contact with the transmission member 72 only when the swing arm 7 is in the highest position or a position near the highest position, and does not contact the transmission member 72 when the swing arm 7 is positioned lower than the highest position. With the above arrangement, since the contact 94 does not contact the transmission member 72 in a normal state in which a relatively large load is not applied to the suspension 74, it is possible to prevent abrasion of the contact 94. This, however, is not limiting, and the contact 94 may contact the transmission member 72 in a normal state.

The contact 94 is positioned so as to contact the transmission member 72 prior to the transmission member 72 contacting the connection 30c of the motor case 30 while the swing arm 7 is moving upward. For example, the contact 94 is positioned lower than the connection 30c of the motor case 30 in the circumferential direction with the output shaft 35 (or the upper end of the driving side rotating member 37) defining a center of the circumference (i.e., the transmission member 72 makes contact with the contact 94 before making contact with the connection 30c as the transmission member 72 moves in the circumferential direction around the center of the output shaft 35). Further, the contact 94 may be positioned higher than the lower end of the battery case 20 as long as the contact 94 makes contact with the transmission member 72 prior to the transmission member 72 contacting the battery case 20 while the swing arm 7 is moving upward.

Further, it is preferable that the contact 94 does not simultaneously make contact with the transmission member 72 with the chain roller 65. That is, it is preferable that the contact 94 makes contact with the transmission member 72 after the chain roller 65 separates from the transmission member 72 while the swing arm 7 is moving upward. With the above arrangement, an excessive increase of the tension of the transmission member 72 is prevented due to the chain roller 65 and the contact 94 simultaneously making contact with the transmission member 72.

As described above, the movement restrictor 9 is provided to advantageously prevent the transmission member 72 from contacting the connection 30c of the motor case 30. This increases the freedom in layout. That is, without the restrictions caused by contact between the transmission member 72 and the connection 30c of the motor case 30, it is possible to reduce the front-back length of the electric vehicle 1, to enlarge the battery 23 in the front-back direction in order to ensure a larger capacity, and to mount the battery 23 in a lower position to ensure a low barycenter. Further, it is not necessary to limit the movement range of the swing arm 7.

Although preferred embodiments of the present invention have been described in the above, the present invention is not limited to the above described preferred embodiments, and various modified preferred embodiments are possible for a person skilled in the art.

It will be appreciated that the preferred embodiments of the present invention hereinbefore described is given by way of example only, and is not intended to limit the scope of the present invention in any way.

It will be appreciated that the term vehicle or motor vehicle that is straddled as used herein, and as used in the art, is meant to include the following terms also used in the art: straddle-type vehicle or motor vehicle, saddle-ride type vehicle or motor vehicle, saddle-straddling type vehicle or motor vehicle, and includes: motorcycles and motorbikes as well as motor tricycles, quadbikes, All Terrain Vehicles (ATVs), scooters, mopeds and snowmobiles.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric vehicle comprising:
a vehicle body frame;
a swing arm supported on the vehicle body frame via a pivot shaft so as to swing in an up-down direction;
a rear wheel supported on the swing arm;
an electric motor;
an output shaft to which a driving force of the electric motor is transmitted;
an endless transmission member that transmits a driving force outputted from the output shaft to the rear wheel;
a battery that supplies power to the electric motor; and
a battery case that houses the battery; wherein
the output shaft is positioned lower than a lower end of the battery case and more forward than a rear end of the battery case in a side view of the electric vehicle; and
a movement restrictor that contacts the transmission member to restrict upward movement of the transmission member is mounted on the vehicle body frame or a member fixed to the vehicle body frame.

2. The electric vehicle according to claim 1, wherein the pivot shaft is positioned lower than the lower end of the battery case and more forward than the rear end of the battery in the side view.

3. The electric vehicle according to claim 1, wherein the transmission member and the battery case at least partially overlap each other in a plan view of the electric vehicle.

4. The electric vehicle according to claim 1, wherein the movement restrictor contacts the transmission member at a position more rearward than the rear end of the battery case.

5. The electric vehicle according to claim 1, further comprising a suspension positioned between the vehicle body frame and the swing arm, wherein the movement restrictor contacts the transmission member at least when the suspension is in a most contracted state.

6. The electric vehicle according to claim 1, wherein the movement restrictor is positioned lower than the battery case in a circumferential direction with the output shaft defining a center of the circumference.

7. The electric vehicle according to claim 1, wherein
the vehicle body frame includes a rear frame extending diagonally rearward and upward from a position behind the battery case; and
the movement restrictor is mounted on a front end portion of the rear frame.

8. The electric vehicle according to claim 1, wherein the movement restrictor is mounted on the battery case.

9. The electric vehicle according to claim 1, further comprising:
a motor case that houses the electric motor; wherein
a lower edge of the battery case and an upper edge of the motor case are assembled together or are or in abutment with one another.

10. The electric vehicle according to claim 1, further comprising:
a motor case that houses the electric motor; wherein
a recess on the motor case opens at least downward; and
the transmission member is positioned inside the recess.
